(19) United States
(12) Patent Application Publication
(10) Pub. No.: US 2023/0256348 A1
(43) Pub. Date: Aug. 17, 2023

(54) METHOD AND SYSTEM OF PROCESSING AND ANALYZING PLAYER TRACKING DATA TO OPTIMIZE TEAM STRATEGY AND INFER MORE MEANINGFUL STATISTICS

(71) Applicant: Benjamin Deyerle ADAMS, Mount Pleasant, SC (US)

(72) Inventor: Benjamin Deyerle ADAMS, Mount Pleasant, SC (US)

(21) Appl. No.: 18/137,275

(22) Filed: Apr. 20, 2023

Related U.S. Application Data
(63) Continuation of application No. PCT/US2021/055618, filed on Oct. 19, 2021.
(60) Provisional application No. 63/174,189, filed on Apr. 13, 2021.
(60) Provisional application No. 63/094,329, filed on Oct. 20, 2020.

(51) Int. Cl. A63F 13/828; A63F 13/798

(52) U.S. Cl. CPC A63F 13/828; A63F 13/798

(57) ABSTRACT

Provided are computer-implemented technologies of processing and analyzing player tracking data to optimize team strategy and infer more meaningful statistics. The technologies use large volumes of raw sports performance data to provide predictive sports information models and/or gather insights from past sports events by using a holistic, non-static analysis. Specifically, the technologies (a) use one or more algorithm(s) to interpret, extract, derive, and then store desired critical ball and player spatial and temporal data from the voluminous sports performance data, (b) further uses a predictive programming model supplied by the user to provide the desired predictive information sought by the user based upon the user's sporting information objectives.

### CROSS-REFERENCE TO RELATED APPLICATION

This application is a continuation of international application No. PCT/US2021/055618 filed on Oct. 19, 2021, which claims the priority and benefit to U.S. provisional application Nos. 63/094,329 filed on Oct. 20, 2020, and 63/174,189 filed on Apr. 13, 2021, the entire contents of which are hereby incorporated herein by reference.

### FIELD OF THE INVENTION

The present invention relates to the field of data analysis, sports analytics, statistics, and physical science. Specifically, the present system relates to the use of physical and geometric properties derived from the position (and derivatives) of players, the ball and other factors to describe the state of play and, for example, quantify the effect an individual player or group of players on the physical and/or geometric state of the match in a given moment or over large amounts of time.

### BACKGROUND OF THE INVENTION

There are many examples of the use of statistics to measure or improve performance across many different sports. Often statistics such as goals, shots, passing percentage and many others are aggregated in order to measure individual performance and describe the effect a player has in a game or over the course of many games. Although individual statistics are very useful, they often fail to reflect how a player will perform as a part of a team, current or prospective, or a new strategy.

Thus, other sports data has been adopted. One example of a popular analytical statistic in soccer (football) is expected goals (xG), which essentially gives each scoring opportunity a weight equal to its scoring probability in order to give a statistical average of the number of goals scored given those chances. Penalty kicks have an expected goal value of 0.73 since they are converted 73% of the time roughly.

A common methodology is to assign xG based on the (X,Y) coordinates on which they occur relative to the goal mouth, giving far greater xG to chances that occur centrally and closer to the goal. This information also can be used, for example, to understand if a team is over/under preforming offensively over a given stretch of time based on if they are lucky or unlucky with their ability to convert their chances into goals.

Such statistics, however, are limited by their specificity and lack of context. xG and other conventional statistics are intended to measure outcomes but often fail to capture the situations that created these outcomes. The solution to this problem has previously been to design more specific statistics in order to capture more specific outcomes. This can get cumbersome and confusing as these statistics become more specific and contrived in order to fit more specific criteria.

In an effort to capture a more holistic overview of sports, analysts have turned to capturing tracking data where (by video or other means) player location data is recorded and analyzed to understand what goes on over the course of a match. This has opened the door to the development of new types of models to describe what happens during matches and who may have the upper hand at any given time based on this location data.

These technologies are very new, so models in use have been recently developed and are continuously being updated. One example of a popular tracking-based model in soccer is pitch control. In general terms this model calculates the areas on the pitch where each team would have control of the ball based on if it were suddenly dropped at that location. This is determined using the player tracking data and interpreting their vector velocity to calculate who would get to the given location first.

Essentially what pitch control then provides is a visualization of the entire field of play with a concrete view of the areas that each team “control” based on who would most likely get to the ball first if it suddenly appeared there. However, pitch control is a very simplistic approach and not very realistic view of what's really happening in the game. While it is a useful model in some situations the idea of the ball appearing out of thin air is not applicable in most situations.

Another sometimes helpful and popular model for soccer is the pass probability model, which uses the tracking data of the players and their vector velocities to compute where on the field of play it would be most likely to be able to complete a pass successfully. These models allow for retrospective analysis of decision making that can be very helpful for players as they can see clearly in these visualizations where they went right or wrong. These models are maximized in theory by players increasing their own or their teammates pass success. However, while this is valuable in certain contexts, these models don't adequately describe the value of different types of passing i.e. which passes create scoring opportunities, although more sophisticated implementations do attempt to solve this issue. Furthermore, not all passes are possible in certain situations.

Finally, a further major model being used in soccer at the moment is pass impact which attempts to address the problem that the pass probability model faces in that it assigns value to the space on the pitch based on how dangerous it is in terms of scoring chances, which for all practical purposes means how close to the goal is it. Optimization within this model involves player positioning very close to the goal in order to occupy the most dangerous point at all times.

This however is limited in context as it only applies to attacking situations and fails to capture fluid buildup play and certainly wouldn't favor “playing out of the back”, as is the current fashion of the top teams.

In short, these models are very limited in context as they do a very good job at measuring a specific positional element of the game while still missing much of the overall scheme of what's happening in the broader context of the game.

An even more recent approach is described in “Seeing into the future: using self-propelled particle models to aid decision-making in soccer,” by Francisco Alguacil, Javier Fernandez, Pablo Arce and David Sumpter, presented at the MIT Sloan Sports Analytics Conference, Mar. 6-7, 2020. It examines three playing zones relative to the position of the soccer ball and uses a limited form of spatial-temporal tracking data. Based upon the collective motion of animal groups called “self-propelled particles” (SPP), the authors evaluated potential models of player co-operation. However, the authors admit that “we could not find any one simple optimization criteria which players tend to follow” (p. 13).

The authors also admit maybe “player zones can be automatically identified by algorithm” but they opted not to use that approach and, rather, “in order to get useable results in the current study we manually assigned roles to the players” (pp. 13-14). This led them to make a general conclusion that passing (passing probability PP) and pitch impact (PI) tend to lead to optimization of results (p. 14). However, this is relatively obvious information that is well known to both players and coaches.

In summary, the SPP article merely teaches that a limited number of individual plays should be used as discussion points with players “to explore alternatives to the decisions they actually made.” (Id). The authors claim that “Coaching based upon the output of a simulation model has never been attempted in soccer” (p. 16). However, this seems hardly credible because showing film of individual players as a means of coaching is routinely used in American football and other sports—both during and after games.

The article admits two further shortcomings. First, it concedes that “none of our models captured player movement . . . better than standing still” (p. 17). Second, the authors' aim is limited to building “a set of coaching tools that explain what players do and suggest alternative[s] in certain situations” (Id). As summarized by the authors, their “ultimate aim is not to build a complete soccer simulation” (Id).

At best, the prior art models are “coaching tools” whereby a limited set of information is used by the coach to get players to discuss and analyze whether better techniques could have been employed. Typically, a relatively small number of plays will be analyzed via this method. Also, they will be viewed in a non-holistic manner—i.e., what would have been a better individual pass, was the specific shot worthwhile, was the particular attacker in the best position?

### SUMMARY OF THE DESCRIPTION

Provided is a computer-implemented method of processing and analyzing player tracking data to optimize team strategy and infer more meaningful statistics. The method comprises: receiving, storing and processing a set of raw data related to a dynamic sports game or a sports practice; extracting a set of sports analytic data from the set of raw data by using at least one algorithm to measure, against a set of criteria chosen in the at least one algorithm, predict and infer performance and values of the teams or players involved in the dynamic sports game or the sports practice, based, at least in part, upon spatial and temporal relationships derived from the set of raw data, wherein the step of measuring comprises: measuring actual past or potential future interactions based, at least in part, upon a holistic and non-static spatial relationship between a ball and at least one player within at least a part of the playing field and wherein the measuring comprises calculating values using based on information or the derivative thereof, about spatial positions on the field, angles, distances, speeds, accelerations, and position imbalances. The method further comprises outputting the sports analytic data; and utilizing the set of sports analytic data, by comparing, ranking, or extrapolating the values presented in the set of sports analytic data, to calculate player or team values, to make player hiring or salary decisions, to improve the performance of one or more team players, or to improve team playing strategy.

Provided is a system that comprises one or more computer processors, one or more computer-readable memories and one or more computer-readable, tangible storage devices, and one or more databases; and computer readable program instructions, stored on at least one of the one or more computer-readable, tangible storage devices for execution by at least of the one or more computer processors via at least one of the one or more memories, to perform operations. The operations comprises receiving, processing and storing a set of raw data related to a holistic and non-static sports game or a sports practice representing the location or movement of a ball and one or more players that involve in the sports game or practice, wherein the location or movement of the ball and the one or more players is the spatial and temporal relationships of the ball and the one or more players; receiving a set of performance criteria data provided for evaluating the set of raw data; comparing the set of raw data with the set of performance criteria data; converting at least some of the set of raw data into a set of analytical data by measuring, predicting or inferring player or team values; creating and then outputting a set of output data based on at least some of the set of analytical data; displaying at least some of the set of output data to evaluate or improve team strategy, player performance, or player selection.

Provided is yet another computer-implemented method of holistically assessing sports team and player performance. The method comprises: receiving a set of video game images or a set of tracking data collected by wearable tracking devices worn by sports players during sports practices; deriving a set of player or team sport performance data from the set of video game images or the set of tracking data; receiving at least one set of performance criteria; producing a set of holistic and non-static predictive sports analytics data by using at least one predictive sports analytic program or algorithm to assign player or team values by measuring, predicting or inferring from the set of player or team performance data, wherein said at least one program or algorithm measures past sports interactions based, at least in part, upon a holistic and non-static spatial and temporal relationship between the movement of a ball and at least one player within at least a part of the playing field, and wherein the measuring comprises predicting, inferring or calculating values using spatial positions of the ball or the player on the field, angles, distances, speeds, accelerations, position imbalances or any derivatives thereof; and outputting a set of desired user data based upon the set of holistic and non-static predictive sports analytics data and the set of performance criteria.

### BRIEF DESCRIPTION OF THE DRAWINGS

The present invention is illustrated by way of example and not limitation in the figures of the accompanying drawings in which like references indicate similar elements.

FIG. 1 illustrates, in a schematic block diagram, a computing environment being used in accordance with certain embodiments. The environment, in certain embodiments, may include artificial intelligence (AI) features (not shown, but are implicit in the Computer Programs).

FIG. 2 illustrates a principle of defensive equilibrium, according to certain embodiments.

FIG. 3 illustrates a principle of positional optimization, according to certain embodiments.

FIG. 4 illustrates a principle of an angle of imbalance, according to certain embodiments.

FIG. 5 illustrates how a player with a quality advantage over his/her defender while attacking the goal forces the defender back and creates an imbalance, according to certain embodiments.

FIG. 6 illustrates how a group of players with a numerical advantage over their defender while attacking the goal forces the defender back and creates an imbalance, according to certain embodiments.

FIG. 7 illustrates that a ball exerts force and also how the force can be expressed not as a single vector but as a vector field, according to certain embodiments.

FIG. 8 illustrates a flowchart for a utilization of certain embodiments.

FIG. 9 illustrates a flowchart for another utilization of certain embodiments.

FIG. 10 illustrates a flowchart for a further utilization of certain embodiments.

FIGS. 11-14 show algorithms related to General Networks used in certain embodiments

### DETAILED DESCRIPTION

Various embodiments and aspects of the inventions will be described with reference to details discussed below, and the accompanying drawings will illustrate some embodiments. The following description and drawings are illustrative of the invention and are not to be construed as limiting the scope of the invention. Numerous specific details are described to provide an overall understanding of the present invention to one of ordinary skill in the art.

Reference in the specification to “one embodiment” or “an embodiment” or “another embodiment” means that a particular feature, structure, or characteristic described in conjunction with the embodiment can be included in at least one embodiment of the invention but need not be in all embodiments. The appearances of the phrase “in one embodiment” in various places in the specification do not necessarily all refer to the same embodiment.

Embodiments use a computer system for receiving, storing and analyzing sport performance data and for providing information to optimize team playing strategy and/or individual player hiring strategy. Optimally and/or alternatively, the system employs artificial intelligence.

One feature of the provided computer-implemented method or the provided system is to use computer data systems and/or artificial intelligence to provide, at least in part, a holistic, non-static approach whereby coach and team management can adopt improved or optimized strategies in terms of existing team players that goes well beyond merely relying upon the prior art coaching tools. For example, alternative offensive and defensive team strategies are taken into consideration by evaluating a large set of each player's past performances to identify habits and tendencies of the player under evaluation that may undermine or support an overall team strategy, offensive or defensive.

Another feature of the provided computer-implemented method or the provided system is to provide a more effective approach to the selection of new players for a prospective team. While the so-called best players are typically measured by statistical models, those best players may not fit in well with the existing players and/or strategy of the prospective team.

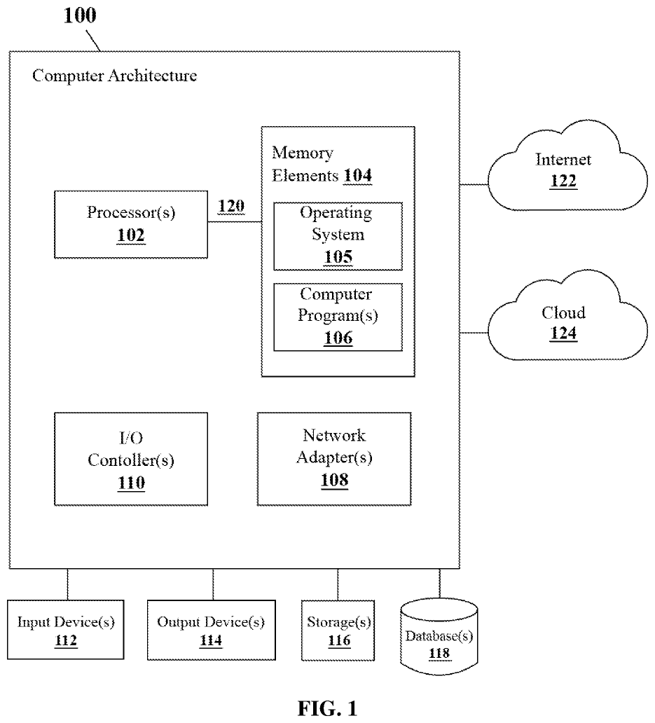

FIG. 1 illustrates a computer architecture 100 that may be used in accordance with certain embodiments. In certain embodiments, the raw sports data collection, storage, and process use computer architecture 100. The computer architecture 100 is suitable for storing and/or executing computer readable program instructions and includes at least one processor 102 coupled directly or indirectly to memory elements 104 through a system bus 120. The memory elements 104 may include one or more local memories employed during actual execution of the program code, bulk storage, and cache memories which provide temporary storage of at least some program code in order to reduce the number of times code must be retrieved from bulk storage during execution. The memory elements 104 include an operating system 105 and one or more computer programs 106, and the operating system 105, as understood by one skilled in the computer art, controls the operation of the entire computer architecture 100 and the architecture 100's interaction with components coupled therewith such as the shown components (input device(s) 112, output device(s) 114, storage(s) 116, databases 118, internet 122, and cloud 124) and unshown components that are understood by one skilled in the art, and the operating system 105 may be switched and changed as fit.

Input/Output (I/O) devices 112, 114 (including but not limited to keyboards, displays, pointing devices, transmitting device, cell phone, verbal device such as a microphone driven by voice recognition software or other known equivalent devices, etc.) may be coupled to the system either directly or through intervening I/O controllers 110.

Input Devices 112 receive sports performance input data (raw and/or processed), and instructions from a user or other source. Sports performance input data includes, inter alia, (i) normal sports statistics (such as shots or goals), (ii) popular sports analytical data (such as xG data), (iii) popular team strategies (such as playbooks, manuals, texts, speeches or the like), (iv) player and/or team game film (such as in video or digitized formats) and (v) data produced by proprietary analytical tools of a team or its coaches, and (vi) tracking data collected from wearable devices worn by players (such as wearable camera, wearable sensors, etc.)

Network adapters 108 may also be coupled to the system to enable the data processing system to become coupled to other data processing systems or remote printers or storage devices through intervening private or public networks. Modems, cable modem and Ethernet cards are just a few of the currently available types of network adapters 108. Network adapters 108 may also be coupled to internet 122 and/or cloud 124 to access remote computer resources.

The computer architecture 100 may be coupled to storage 116 (e.g., any type of storage device; a non-volatile storage area, such as magnetic disk drives, optical disk drives, a tape drive, etc.). The storage 116 may comprise an internal storage device or an attached or network accessible storage. Computer programs 106 in storage 116 may be loaded into the memory elements 104 and executed by a processor 102 in a manner known in the art.

Computer programs 106 may include AI programs or machine learning programs, and the computer programs 106 may partially reside in storage 116 and partially reside in cloud 124 or internet 122.

The computer architecture 100 may include fewer components than illustrated, additional components not illustrated herein, or some combination of the components illustrated and additional components. The computer architecture 100 may comprise any computing device known in the art, such as a mainframe, server, personal computer, workstation, laptop, handheld computer, telephony device, network appliance, virtualization device, storage controller, virtual machine, smartphone, tablet, etc.

Input device(s) 112 transmits desired sports performance data to processor(s) 102 via memory elements 104 under the control of operating system 105 and computer program(s) 106. The processor(s) 102 may be central processing units (CPUs) and/or any other types of processing device known in the art. In certain embodiments, the processing devices 102 are capable of receiving and processing sports performance input data from multiple users or sources, thus the processing devices 102 have multiple cores. In addition, certain embodiments involve the use of game film (i.e., graphics intensive information) or digitized information (i.e., digitized graphics), these embodiments therefore employ graphic processing units (GPUs) as the processor(s) 102 in lieu of or in addition to CPUs.

Certain embodiments also comprise at least one database 118 for storing desired sports performance data. Some raw sports performance input data are converted into digitized data format before being stored in the database 118 or being used to create the desired output data. It's worth noting that storage(s) 116, in addition to being used to store computer program(s) 106, are also sometimes used to store sports performance input data, raw or processed, and to store sports analytical data. The permanent storage of sports performance input data and sports analytical data is primarily database(s) 118. It's also noted that the database(s) 118 may reside in close proximity to the computer architecture 100, or remotely in the cloud 124, and the database(s) 118 may be in various forms or database architectures.

Because certain embodiments need a storage for storing large volumes of sports performance input/analytical data, more than one database likely is used. For example, in the context of at least the above-stated goals, sports performance input data relating to soccer teams and their individual player may encompass about 1, 2 or more years of game information for many teams and individuals encompassing Europe, South America, the US, and/or other additional geographic areas. Likewise, depending upon the user, the sports performance input data may cover one or more leagues—e.g., the British Premier League, Bundesliga, La Liga, France Ligue 1 or Serie A.

Additionally, if a user is interested in potentially hiring a player, the sports performance input data as to the player over a relatively long period of time to be stored in the database(s) 118 may be the player's entire sports performance in more than one team with which the player has engaged during the long period of time. Consequently, over time the sports performance input data stored in the database(s) will likely become quite voluminous.

The provided method and/or system uses one or more sets of performance selection criteria (user inputted or embedded in the computer programs 106 in use) to compare and analyze sports performance input data using the computer programs 106 or algorithms embedded therein to create desired team and/or player information as one or more sets of output performance data. These computer programs 106 or algorithms therein apply the sports performance input data and the one or more sets of performance selection criteria for evaluating that input data. Specifically, the provided method and/or system then uses one or more sets of performance selection criteria to establish player or team measurement values so as to evaluate the large amounts of game/practice data represented in the sports performance input data and assign player quality values as well as other values that are deem relevant to the evaluation. The sets of performance selection criteria may be evaluated one at a time or in conjunction of two or more sets of criteria. The measurement values may be binary, categorical, numeric, or any other type of data.

Since static historical data (such as goals scored, shots on goals, passing percentages and the like) only provide a limited set of information to sports teams and other users, static historical data is not the critical part of certain embodiments, and thus may not be stored in the database(s) 118 and be applied in computer program(s) 106 and the algorithms therein. Thus, the provided method and/or system primarily use the holistic and non-static analysis of large amounts of data input for at least some of the programmed and computerized analysis. In a preferred embodiment, the holistic and non-static approach is the primary evaluation tool. Consequently, the provided method and/or system is used in a set of predictive analyses of relatively large amounts of sports performance input data, including (but not limited to) data spanning about 1 to 1½ years of time or more, and/or spanning across different professional leagues and/or professional teams. Examples of predictive analyses for soccer include, but are not limited to:
Evaluating the last 4-5 touches prior to a shot on goal (and/or defense against those touches) in terms of both players and locations of the ball/players on the field
Evaluating the offensive/defensive patterns of individuals or groups of players vis-à-vis the movement of the ball and/or location on the field of play
Evaluating turnovers in terms of players, movement of the ball and/or field location
Evaluating movement of the ball after release from the goalkeeper to across mid-field (or beyond) in terms of offense and/or defense
Evaluating player substitution effectiveness as a ratio of time and/or player position

Above list merely shows a small number of uses of linear or non-linear predictive performance analyses in soccer. Likewise, the same predictive performance analyses may be applied in other team sports such as American Football, Rugby, Ice Hockey, Water Polo, Lacrosse, etc.

The output device(s) 114 are the devices conveying visually (such as via one or more monitors, televisions or other display devices), audibly (such as one or more speakers) and/or otherwise (such as printers, fax machines, smartphones, terminals, telegraphs, etc.) to the user the sought sports performance analytical data

As a person of ordinary skill in the art would recognize, the computer hardware involved in the use of the embodiments may be generic hardware that can be obtained by from many existing sources, and each of the computer architecture 100's components (102-118 with the exception of Computer Program(s) 106) may be incorporated directly into the provided system and/or method or be connected to the provided system and/or method.

Conversely, the software aspect (i.e., some of the Computer Program(s) 106) of the embodiments are unique and it is the core of the embodiments that carries out and enables the functionalities of holistic analysis of sports data underlying the embodiments.

It is noted that FIG. 1 is meant to schematically illustrate a general configuration of a computer system that are used by the provided system and/or method, and that FIG. 1 is meant to also cover variations and/or extension of the shown architecture/configuration that are within the understanding of those skilled in the art. That is to say, additional devices or reduction of components may be possible, so long as they are within the understanding of those skilled in the art.

In an embodiment, the provided system and/or method may receive input data from the one or more users, from one or more third-parties or from a combination of both. Ultimately, the provided system and/or method will generate output sports performance data to the user(s) (sports teams or otherwise), or to one or more third parties (such as paid, licensed, and/or authorized entities).

The sports performance input data usually are received via an input device(s) 112 (such as a receiver) prior to be fed into the processor(s) 102. Further, in the event that the data is received from a third-party, the receiver, the processor, or one or more associated intermediate devices may need to decrypt, normalize, digitize, and/or convert the sports performance input data before it can be processed within the provided system and/or method. The decryption or normalization or conversion devices (not shown in FIG. 1) may be separate units or they may be incorporated into input device(s) 112, processor(s) 102 or elsewhere.

The implementation of the software aspect of the provided system and/or method is not limited to any specific software programming environment or programming language, as sports teams and companies around the world likely utilize a variety of computer programing environments and languages that are convenient and available to them. However, there are a few invariable core steps in implementing the software aspect (i.e., computer readable instructions) of the provided system and/or method. First, the sports performance input data must be stored in one or more computer readable memory (such as the memory elements 104) or storage (such as the storage(s) 116) or one or more databases (such as database(s) 118); then, the sports performance input data is analyzed by using the desired performance evaluation steps encoded in the computer program(s) 106; and subsequently, the programmed analysis yields desired output data, which is to be either outputted via output device(s) 114 or stored in storage(s) 116. In that regard, the source code for implementing the software aspect may be written in one or more than one language, and the implementation can be a monolithic block of software or a multiple distributed blocks that cooperate with each other to carry out their intended functionalities. Aside from the above-mentioned core steps, other accessory intermediate steps, between the input and output steps, may be employed in the provided system and/or method invention if the computing circumstances warrant.

The software aspect of the provided system and/or method may also employ artificial intelligence (AI) because, inter alia, analyzing a large volume of sports performance input data for multiple teams and/or players over a sufficiently long period of time for the purpose of identifying the team/player habits requires deep understanding the patterns and intricacies hid underneath the input data, and thus discovery power of AI is tapped to fulfil the purpose. In the preferred embodiment, the AI system may be carried on in or be embedded in field-programmable gate arrays (FPGAs). On the other hand, with or without the aid of AI, the provided system and/or method, in certain embodiments, extrapolates past performance data in connection with multiple sports strategies.

In certain embodiments, the provided system and/or method may use of one or more algorithms that set forth the process rules (i.e., the rules are embedded in the computer program(s) 106 that carry on the analysis process) for the computer system operations or performance measuring equations for making calculations used in ultimately creating the desired data output information. On the other hand, the process rules may be provided by the users and stored in the storage(s) 116, and the rules can be flexibly altered via, for example, users' edit, without changing the computer program(s) 106.

While in some embodiments, the calculations embodied in the algorithms may be linear, in other embodiments, the calculations embodied in the algorithms may be non-linear equations. In fact, the algorithms implemented in the computer program(s) 106 may involve linear, non-linear or both types of calculations.

For example, while some embodiments include basic static sports performance data (such as scoring or saves) and the algorithm therein assigns values to the basic static sports performance data, the analysis of team/player actions in actions carried on by these embodiments covers many different aspects of a game under the analysis. In one aspect of these embodiments, during a soccer game, a team actions (as a whole and/or as an individual player) can be analyzed during long periods of time vis-à-vis where the ball is, where individual players are, and what strategies are employed.

In order to carry on the multi-aspect analysis, AI is used to conduct deep learning and to enable automatic machine learning to parse through the large volumes of input data, such as text (like soccer strategies), images (like video) and verbal information, to discover insightful patterns underneath the data that is otherwise unseen-able. AI, a mimic human thinking on an expedited basis, when parsing through the sports performance input data, makes sense of each data points and draws connections between the meaning of data points and then making correlations among data points, and ultimately provides pseudo-cognitive information, in which case, the program algorithms and instructions of the certain embodiments set forth the framework for the pseudo-cognitive information, and the AI therein learns from the sample data within the framework to draw learned experience and then applies the learned experience to infer conclusions from a new set of input data. Just as weak artificial intelligence has been used to learn and play chess, the AI employed in some embodiments can be used to learn from a set of sample sports performance input data to derive winning sports strategies and insights for improving player hiring in much more complicated situations such as soccer and other sports.

All the embodiments require a computer readable and executable program embedded in a computer readable and tangible medium that is designed to perform holistic sports data analysis. The program carries on one or more algorithms directed to the specific sports data that is to be analyzed and to the desired sports performance data that is to be output to the users. The one or more algorithms employ one or more equations to either derive meanings of existing data points or to derive derivative data points.

Examples of equations, including differential equations, that may be employed include, but are not limited to:

$${q}_{d} \frac{{d}^{2} r}{{dt}^{2}} = C \frac{{q}_{d} {q}_{2}}{{r}^{2}} , \qquad ( Equation \#1 )$$

where q_{d} is the quality of a defender, r is the distance between the player “particles”,

$$\frac{{d}^{2} r}{{dt}^{2}}$$

is the second derivative of r with respect to time, C is an inferred constant, and q₂ is the quality value of an attacker or the constant “charge” value associated with the ball;

$$V = k \frac{Q}{r} , \qquad ( Equation \#2 )$$

where V is the potential of a player “particle”, k is the electrostatic constant, Q is the charge of the player “particle”, and r is the distance to that particle.

The equations above are only a couple of examples of many equations applied in certain embodiments to derive output sports performance data from raw sports performance data, and all applied equations are subjected to adjustment with different parameters/constants to meet different performance evaluation criteria. New equations may be applied to replace or to add upon existing equations applied in the embodiments.

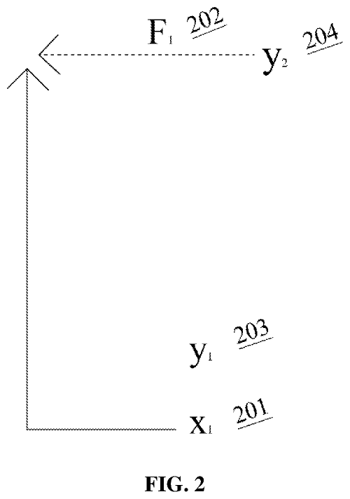

It is noted that although the provided system and/or method applies to many different team sports, what will be discussed in more detail hereinbelow (with the exception of FIG. 2) will use soccer as an example to present the underlying approaches and details, as soccer is widely played throughout the world and thus explanation of the underlying approaches and details via soccer could be universally understandable. Using soccer as a venue to disclose the details of the embodiments, however, should not be construed that the embodiments are limited to soccer, and in fact, the embodiments are readily adapted to sports performance information analysis for other team sports.

In one embodiment, the output sports performance data would be the total “force” applied by individual players on other system elements over the course of a particular season as a metric of measuring the players' total impact on games they participated over the season and identifying the games in which the players overperformed or underperformed relative to their standards.

In another embodiment, with related to the above-mentioned embodiment, the output performance data would be the total distance that the players forced the other teams' players to move as a result of force imbalances the enforcing players created. This metric would be another way of quantifying the effect these force imbalances can have on a defense.

In a further embodiment, the output sports performance data would be the frequency at which the players failed to make movements to negate nearby force imbalances as a metric of measuring the players' rate of positional decision-making error.

In another embodiment, the output sports performance data would be the identification of weak points in an opponent's defensive shape/scheme, or personnel/points that require the least force to influence.

In yet another embodiment, based on output sports performance data such as the above-mentioned data, machine learning algorithms may be applied to identify what patterns of player movement result in the greatest force imbalances in matches, and the patterns identified may be used to optimize team strategy by improving player movement patterns.

In yet another embodiment, a player who has a high capacity to exert force in attack has a higher probability of overcoming a defender who has a lower capacity to negate the attacking player's force in defense, and teams could conduct analyses before games to identify winning probability matchups in different areas of the field in order to coach their players where to move the ball and attack.

In another embodiment, the pressing tendencies of a team may be quantified by observing the areas the team's players allow imbalances while out of possession of the ball. Teams that press aggressively always could potentially allow far less imbalances in the midfield and in the opposing teams' half than teams that sit back and allow midfielders and defenders of the attacking team to handle the ball without pressure.

Each of these embodiment examples can be modified so that they are directed to offensive, defensive, midfield and other field-of-play situations.

FIG. 2 schematically illustrates an embodiment of a single element of the game. In the case shown in FIG. 2, the single element is the player X₁ 201, who enacts a force F₁ 202 on player Y₂ 204. The figure shows a common situation in an American football game where a wide receiver X₁ 201 beats the cornerback Y₁ 203, forcing the safety Y₂ 204 to move over to cover the area of advantage that is exposed by the beaten Y₁ 203. More generally, player X₁ 201, by beating Y₁ 203, has enacted a force (F₁ 202) on player Y₂ 204 and has thus affected the state of play. This illustrates a principle of defensive equilibrium in which defenders seek to nullify attacking players, and also illustrates the output sports performance data “force”. When an imbalance is created under a force, the state changes in an attempt to resolve the imbalance.

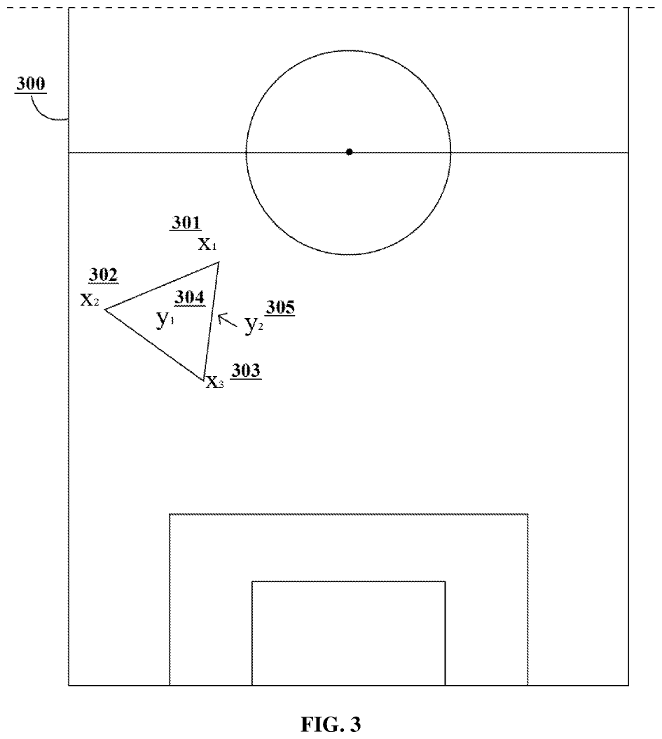

FIG. 3 schematically illustrates another embodiment of a field of imbalance or area of a soccer field 300, in which attacking players X₁ 301, X₂ 302, and X₃ 303 have a collective magnitude of certain impact upon their common opponent Y₁ 304, creating an imbalance. This imbalance creates effect on a nearby player Y₂ 305 (Y₁ 304's team member) who may experience, for example, a force (not shown in the figure) that pushes him towards the field of advantage. This example shows the analysis based on the output sports performance data “force” can be used to improve a team's offensive performance by optimizing positioning of players with the intention of creating the greatest area of fields of advantage.

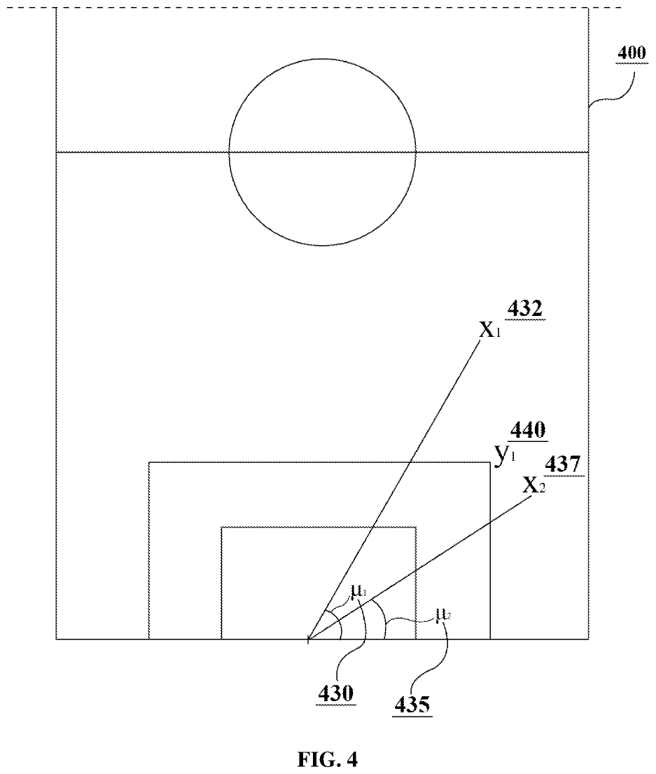

FIG. 4 schematically illustrates a further embodiment of an angle of imbalance, an example of a geometric property of a situation on a soccer field 400. μ₁ 430 is the angle between the bottom boundary line of the soccer pitch 400 and the line connecting the origin (center of goal) to X₁ 432 and μ₂ 435 relates similarly to X₂ 437. Because X₁ 432 and X₂ 437 have an imbalance over Y₁ 440 the area between the angles μ₁ 430 and μ₂ 435 would be described as an angle of advantage. This example shows how a quantified output sports performance data (in this case, an angle of advantage) can be derived from raw sports performance data such as a still image or a video recording of a sports game (or practice), and how a quantified output sports performance data (in this case, the angle of advantage) can open doors for further analysis whose result can benefit decision makings in matches and trainings.

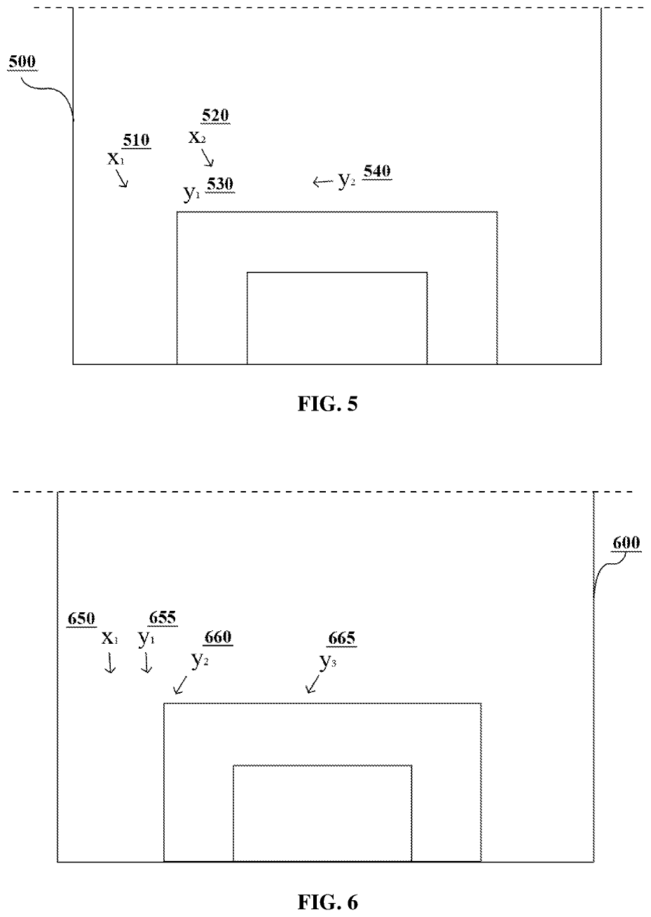

FIG. 5 schematically illustrates an offense/defense scenario on a soccer field 500, how a group of attacking players X₁ 510 and X₂ 520 with a quantitative advantage can force an isolated defender back Y₁ 530 while the defender Y₂ 540 must react and help in order to respond optimally to the imbalance in one embodiment. If the defender Y₂ 540 does not react, the defender Y₁ 530 will eventually be forced to challenge with a high probability of failure due to his huge disadvantage. However once Y₂ 540 arrives and equalizes the situation, the probabilities change and it becomes more favorable to hold ground and step. In this way, the force that the attackers X₁ 510 and X₂ 520 possessed has been neutralized and the equilibrium has been restored. This figure demonstrates that quantified output sports performance data (such as “force” and “equilibrium” in this scenario), being holistic (meaning, the data concerns more than one particle in a sports game) and non-static (meaning, the data takes into account of the passage of time), enable further impactful analysis.

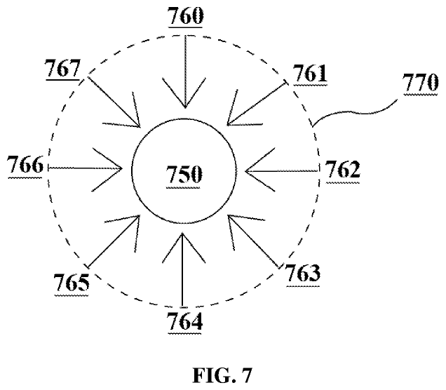

FIG. 6 schematically illustrates another offense/defense scenario on a soccer field 600 in which when attacking player X₁ 650 has a quality advantage over his defender Y₁ 655, X₁ 650 may well force Y₁ 655 back and cause an imbalance. When handled optimally by the defense, X₁ 650's advantage causes a reaction where another defender (such as Y₂ 660) must come and help in order to cancel out X₁ 650's advantage. Y₂ 660's coming to help Y₁ 655 then may leave another gap area which needs filling, and the gap area may require Y₃ 665 to fill. In one embodiment, this scenario could be quantifiably described as the attacker X₁ 650 exerting direct force on defender Y₁ 655 while exerting indirect force(s) on defender Y₂ 660, and even Y₃ 665. This figure demonstrates, once again, how quantified output sports performance data (in this case, direct force, and indirect force(s)), being holistic (meaning, the data concerns more than one particle in a sports game) and non-static (meaning, the data takes into account of the passage of time), open doors for further analysis whose result can benefit decision makings in matches and trainings.

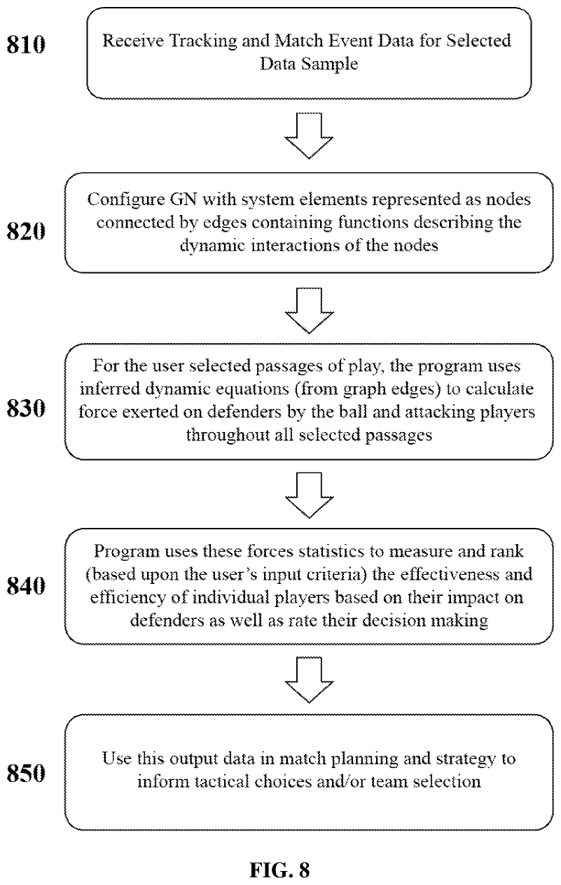

FIG. 7 schematically illustrates how a ball 750 actuates a number of pull forces (such as 760, 761, 762, 763, 764, 765, 766, and 767) on its surrounding elements (e.g., players, not shown) in one embodiment. It also shows how a group of forces (such as 760, 761, 762, 763, 764, 765, 766, and 767) can collectively be expressed as one vector field 770 rather than a group of individual vectors like 760, 761, 762, 763, 764, 765, 766, and 767. In fact, when it comes to quantify the effect of a ball being played in a game/training, a vector field such as 770 is preferred as it is more accurate and effective representation of the effect exerted by the ball. In a sense, the effect field exerted by a ball being played on a field permeates the near space surrounding the ball, and the situation is a lot like the earth exerting its gravitational pull field upon anything on the earth or near the earth, as both fields pull any number of surrounding elements from any angle toward the originators of the fields (i.e., the ball and the earth). This scenario about a ball demonstrates one way of quantifying output sports performance data about the ball's effect in the sports, and the data is part of the holistic data package, as the quantified vector field exerted by the ball concerns not only the ball but also the distance between the ball and an element surrounding the ball. The quantified vector field exerted by the ball is also non-static, as the field comprises directive over time, see above-mentioned Equation #1.

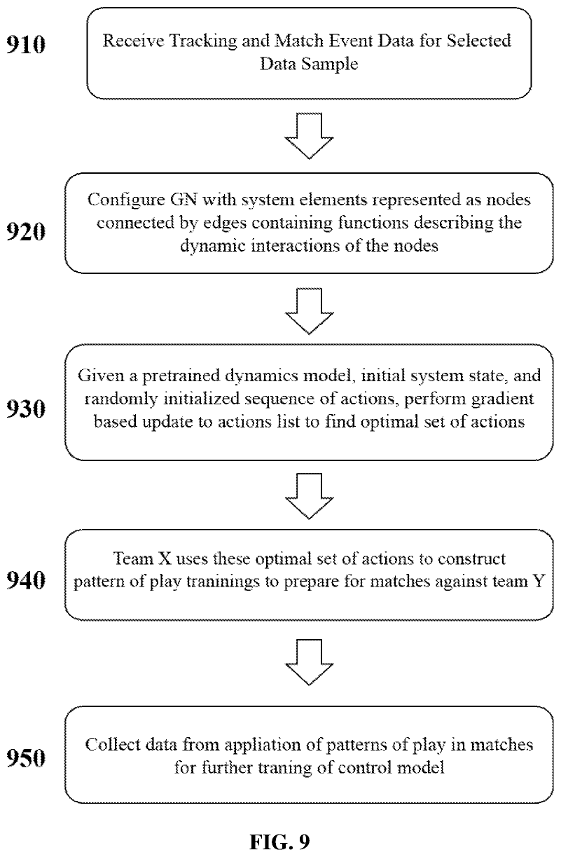

With regard to how the non-static holistic analysis are put in use, hereinbelow are a few examples, through FIGS. 8-10, of overall team strategy and/or player selection for individual matches to demonstrate the utilization of the data in certain embodiments.

For instance, if soccer team X is preparing to play against soccer team Y, team staff/members of X will want to analyze the opposition's players and patterns of play based upon a sufficiently large raw sports performance data set in a holistic and non-static manner in order to prepare strategically and tactically. Below is a sample implementation in certain embodiments, and the sample implementation is by no means to limit possible variations of the sample that meet the need of the goal of the sports performance data analysis and better suit the circumstances.

In one preferred embodiment, the provided system and/or method employs machine learning or AI. Particularly, this embodiment modifies graph networks (GNs) to be used in the context of the analysis of holistic and non-static sports information. Specifically, the provided method and/or system adapts GN algorithms to the invention. See the use of GNs in physics applications in a scientific paper named “Graph Networks as Learnable Physics Engines for Inference and Control”, by Sanchez-Gonzales, et al, 2018 (Proceedings of the 35th International Conference on Machine Learning, Stockholm, Sweden PMLR, 2018), that are expressly incorporated herein. It's worth briefly emphasizing herein that although the teachings presented in the Sanchez-Gonzales paper concern learnable models that help attain richer knowledge about the structure of the physical world, and although team sports and ball games in particular, in a broad and general term, is part of the physical world, the teachings presented in the Sanchez-Gonzales do not, explicitly or implicitly, relate to the analysis of holistic and non-static sports information. Therefore, Sanchez-Gonzales cannot reasonably be a prior art pertinent to the application. The GN model suits the provided method/system because its structure allows for an object- and relation-centric representation of complex, dynamic systems. Hence, the modified GN structure can encompass not merely a forward predictive model, but also an inference model (where certain properties of the system are estimated based upon dynamic interactions of system elements) and control models (where optimization of objective function based on the dynamics of the system is used).

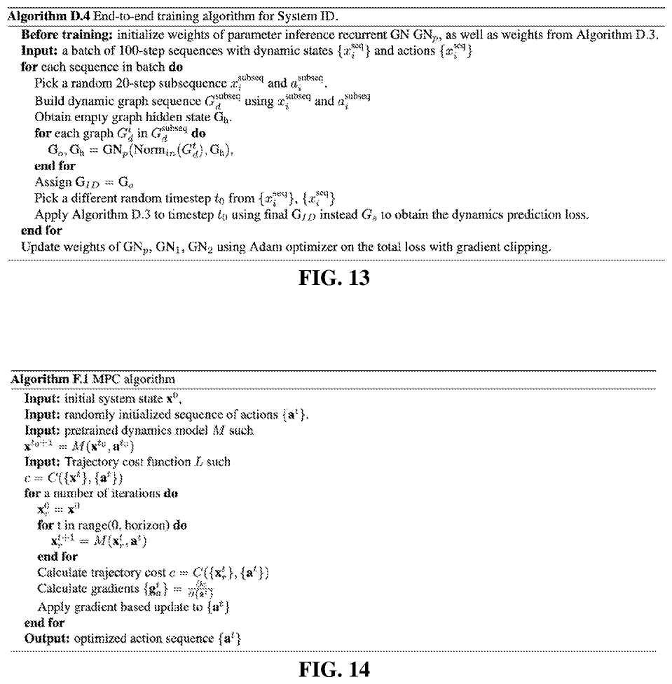

In general, the following shown algorithm (Algorithm 1) demonstrates one way to map an input graph to output graphs with different edge, node, and global features (fₑ, fₙ, and f_{g}, respectively), and FIGS. 11-14 show a few algorithms used in certain embodiments. Specifically, FIG. 11 shows two algorithms: a forward prediction algorithm, and a forward prediction with system identification (ID). FIG. 12 shows a training algorithm for ID phase of building the inference model. FIG. 13 shows a training algorithm for building the inference model. FIG. 14 shows an algorithm for building the control model. These algorithms can be used directly or with relatively small modifications to implement aforementioned three models: predictive model, inference model, and control model.

Algorithm 1 Graph network, GN

```
Input: Graph, G = (g, {nᵢ}, {eⱼ, sⱼ, rⱼ})
for each edge {eⱼ, sⱼ, rⱼ} do
  Gather sender and receiver nodes nₛ_{ⱼ}, nᵣ_{ⱼ}
  Compute output edges, e_{f}* = fₑ(g, nₛ_{ⱼ}, nᵣ_{ⱼ}, eⱼ)
end for
for each node {nᵢ} do
  Aggregate eⱼ* per receiver, êᵢ = Σ_{j/r}_{ⱼ₌ᵢ}eⱼ*
  Compute node-wise features, nᵢ* = fₙ(g, nᵢ, \hat{eₗ})
end for
Aggregate all edges and nodes ê = Σⱼeⱼ*, \hat{n} = Σᵢnᵢ*
Compute global features, g* = f_{g} (g, \hat{n}, ê)
Output: Graph, G* = (g*, {nᵢ*}, {eⱼ*, sⱼ, rⱼ})
```

All three types of models can be used to implement the provided method/system. For example, forward predictive models could simulate possible match outcomes given expected lineups. An inference model could be used to determine player/team “mass” or quality values based upon, inter alia, velocity, acceleration and inferred force interactions. Likewise, a control model could be used to create optimal or improved patterns of play, based upon, inter alia, maximizing disruption of the opposition's offensive or defensive play routines to create better defense or attacking patterns. For these models, the ball, players and other objectives (such as goal area) are represented as nodes in the GN connected by edges. Each node may contain information about the specific object (ball, player, etc.) such as position and velocity while the graph as a whole may contain system-wide information (such as match time, passes, dribbles, tackles, etc.).

First, the tracking data for an adequate sampling period (such as the current season or longer), is received for all league matches of a particular sports league. The data might, for example, be further ranked by the performance criteria, set by user or analytical tool, to give higher weight to more recent matches. In the sample implementation, all the players contained in the tracking data, the ball, and the goals are initialized as nodes in the GNs, and the nodes are connected by edges. Second, a forward prediction model is created using the tracking data over the samples (i.e., training data), updating the edges of the graphs to reflect the relationships among the nodes. These edges store functions that reflect the dynamics of the system, which are updated as the neural network learns the behavior of the system itself through observation (i.e., parsing through the samples). To infer extracted properties of the system, this sample implementation of the provided system and/or method uses these functions (associated with each edge of the GNs) as a basis for its estimations. Third, as a starting point for the inference model, the identification (“ID” hereinafter), or calibration, phase begins consisting of 20% of the sample data in this implementation (actual percentage could vary). The purpose of the ID phase is to validate the function (edge) values inherited from the forward predictive model to ensure the fundamental interactions of the system which are the basis for inferring the properties of the system are sound. Sacrificing a subset of the data for this calibration phase has been shown to increase inference accuracy significantly. Note, in the case of ball games, the parameters are the factor by which each particle in the system has a different capacity to effectuate the acceleration of other particles (i.e., exerted force), and the parameters are what we refer to as the players' quality. Once the ID phase has completed, the remainder of the dataset is used for the inference phase, in which the desired abstract properties (in this case player quality) are determined based on the edge functions of the GN. After the desired parameters of the system are inferred by the GN, the values of said parameters are then saved to a database. In addition to assigning player values, the provided method/system may also assign values to teams. The predictive models, and especially the edges containing the dynamic functions are also saved in a database for later analyses.

Next, in order to analyze individual matches that team Y has played and observe their patterns of play a relevant selection of tracking, match event, and player quality data should be received by the program that contains the GNs in large enough data volume to create the desired sample population (i.e., the population for training data) selected by the user (i.e., step 810 of FIG. 8). In one embodiment, a user, via criteria set by the user, determines what passages of a play or entire matches constitute the sample population based on the user criteria. For example, all of team Y's games may be chosen or only a certain sufficiently large groups of matches based on parameters chosen by the coaching staff based on what games they believe will be most like their match. The user may also select particular attacking patterns of play of team Y for concrete analysis based on the players they believe are likely to play.

Next, a GN is created for analysis, with the method/system elements represented as nodes of the graph and the edges between them holding functions representing their learned dynamic interactions (from the above example). See FIG. 8's step 820. In one preferred embodiment, the provided system/method uses these functions to infer the force exerted by each player or system element by using, for example, equation #1 is used instead, for the purpose of calculating the acceleration caused by the attacking player or ball on the defending player. From acceleration, force is calculated simply over time, as under the equation of F=ma (note, in this case the “mass” is the quality of the defending player), and acceleration “a” is calculated simply over time. If the force is being caused by the ball, it is referred as F_{B} for the given defender, and if the force is caused by an attacker, it is referred as FA. See FIG. 8's step 830.

The next step is to use these force statistics to rank the effectiveness and efficiency of individual players based on their impact on defenders as well as rate their decision making. For instance, players who exert more force on defenders as they move near them throughout the match are ranked higher. See FIG. 8's step 840. Other user defined input criteria can be used to rank players such as how often they dribble at opponent player(s) while having an advantage (higher quality than their opponent or group of opponents), which would be a measure of the dribbling players' decision making. Finally, at the step 850 of FIG. 8, aggregating the ranking information to a set of output data to present to end users, upon which, the coaching staff of team X can make informed decisions in the match planning and strategy for the upcoming game regarding tactics and team selection to be prepared for the opponent teams' attacks and cancel out their best players. For example, staff of team X might observe, via the output data, that team Y attacks down one side with high quality rating players with much higher frequency than the other side. Upon this accurate observation, the coaches of team X would make sure to pointedly construct a defensive strategy in order to thwart team Y's attacks by setting up tactically with enough defenders in position to negate team Y's players. Also, if team X uses the user defined dribbling rankings observed as mentioned above, coaches of team X can emphasize to the relevant players on the team the importance of marking or “double teaming” the high-ranking dribblers in the one-on-one situations.

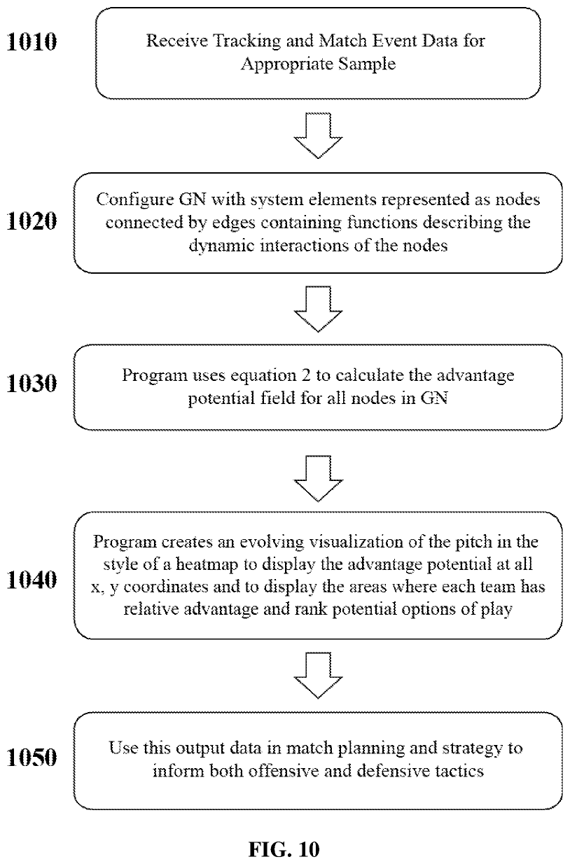

Similarly, FIG. 9 schematically illustrates a use of the provided method and/or system that involves the application of GNs as a control model to produce valuable insights on how teams' tactical setups and patterns affect the opposition. Control models, under some circumstances, may have an advantage that in many applications the control functions turn out to be simpler to interpret than the underlying functions describing the dynamic system, leading to more usable and readable findings. The GN herein is setup as in the previous example demonstrated under FIG. 8, with the nodes representing system elements (players, ball, goals, etc.) and the edges connecting them, with global quantities being stored on the graph. See steps 910 and 920 of FIG. 9. For this embodiment, the objective of the control model is to maximize the force applied to defending players.

There are multiple possible approaches to implementing control models with GNs, and in this embodiment, the provided system/method optimizes the control inputs via gradient decent, to maximize reward from a set of randomized actions (player movements and passes) under a known reward function (force applied to the defending players) (Sanchez-Gonzalez supra.). See 930. Given a known starting state, such as team X lined up against team Y in a common attacking scenario, the control model, after learning from provided sample data (i.e., training data), outputs an optimized action sequence to maximize the reward function. The reward function encodes the optimized patterns of play.

Now at the step 940, team X would have new patterns of play to practice in training. This analysis would be repeated for many different possible scenarios for team X lining up against team Y to produce many attacking patterns for training use. User criteria to change the reward function would allow for customization of the control model to further suit the needs of the team and coaching staff specifically. Furthermore, when these patterns of play are implemented in games the results would be fed back into the model to further calibrate the control function for gaining more accuracy. See 950.

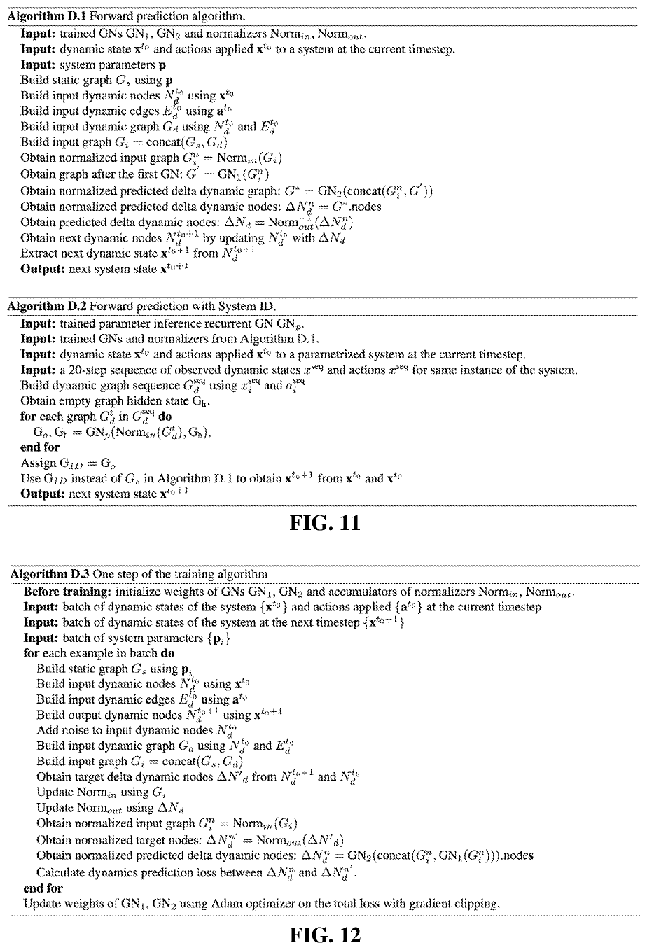

FIG. 10 schematically illustrates yet another embodiment in this sample implementation relates to the fields of advantages. First, at the step 1010, the tracking data, match event data, and player data for the sample (i.e., training data that is to be used to train the GN) are retrieved. The GN is configured as before with the system elements as nodes, their interactions as edges, and system properties as graph variables. See 1020. This analysis makes use of a concept called advantage potential, which represents, for any point in space, how well either team is in control of the particular point in space. Advantage potential of a given particle (e.g., a player) can be visualized as a field around the player that shares its sign and magnitude with the quality of said player (attacking and defending players have qualities of opposite) and decreases in magnitude as the distance increases from the particle. Equation #2 is used for every node to calculate the advantage potential field thereof and store the results onto the graph, adding the fields together in vector fashion where they overlap, see step 1030. For example, if a point in space with the (X, Y) coordinate that is equidistant from an attacker and defender of equal quality (value of opposite sign), these two values with opposite sign would cancel each other's advantage potential at the point of (X, Y). A visualization would be created with positive values in one color (e.g., green) and negative values in another color (e.g., red) to show what areas are controlled by each team and to what degree, see 1040. This visualization is called a heatmap to account for players force potential, or their danger level. A heatmap would be a powerful analysis tool as it is visually (and thus intuitively) representative of the balance of power on the pitch at a given moment of time of a game or training practice (note, the heatmap evolves as potential shifts over the passage of time).

Likewise, at any given time there would be a ranking based upon the user's input criteria of what areas around attacking players have the highest advantage potential value for the attacking team so that if the ball was passed into those areas it would result in promising attacking play. These areas might be characterized as “field of advantage” as described in FIG. 3.

The heatmap is just one example of many visualizations that can be used as coaching tools to analyze decision making to see if the ball could be more effectively into areas of higher advantage potential, or if tactics could be changed to create more areas of high advantage potential. See 1050. Players can be consulted with and shown where they are making mistakes so they understand with visualization tools the logic behind the new actions they are supposed to take, such as a different pass they could make.

In certain embodiments, these advantage potential analyses are applied over many matches to compile scouting data of players who consistently make good decisions, such as passing into high advantage potential areas or as a defender negating areas of high attacking advantage when they arise consistently. This scouting data could be used to decide which players to attempt to buy and for what price based on the value they could potentially provide the team.

In yet another embodiment, the coaches of team X can use wearable tracking devices during practices to provide location data for the system to determine whether or not its players are performing in according with a strategy being adopted for an upcoming game with team Y.

### Additional Embodiment Details

The present invention may be a system, a method, and/or a computer program product. The computer program product and the system may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device or a computer cloud via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++, Java, Python or the like, and conventional procedural programming languages, such as the “C” programming language or similar programming languages, and scripting programming languages, such as Perl, JavaScript, or the like. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

### Additional Notes

It is noted that although the preferred use of certain embodiments involves ball game sports where each team has at least 7-11 players on the field at the same time during play, the applicability of the provided system and/or method is not limited by the nature of the sports and the composition of the sports teams.

It is also noted that throughout the disclosure, the terms of “tracking and match event data”, “tracking data”, “video game images”, “raw data”, “sports performance input data”, and “raw sports performance data” are interchangeable, and they all mean to be the unprocessed sports performance data collected from one or more sports events or sports training sessions.

It is also noted that throughout the disclosure the terms of “analytical data”, “sports performance analytical data”, “quantified output sports performance data”, “output sports performance data”, and “predictive sports analytics data” are interchangeable, and they all mean the kind of processed sports performance data been interpreted, extracted, and/or derived from the unprocessed sports performance data.

It is also noted that throughout the disclosure the terms of “output data” means the data presented and readable to end-users. The “output data” may be the “analytical data” mentioned in the previous paragraph or may be the data as result of further processing and/or analysis of the “analytical data” mentioned in the previous paragraph.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Certain embodiments of this invention are described herein, including the best mode known to the inventors for carrying out the invention. It should be understood that the illustrated embodiments are exemplary only, and should not be taken as limiting the scope of the invention.

What is claimed is:

1. A system, comprising:
one or more computer processors, one or more computer-readable memories and one or more computer-readable, tangible storage devices, and one or more databases; and
at least one set of computer readable program instructions using one or more graph networks having at least one algorithm, stored on at least one of the one or more computer-readable, tangible storage devices for execution by at least of the one or more computer processors via at least one of the one or more memories, to perform operations, the operations comprising:
receiving, processing and storing a set of raw data related to a holistic and non-static sports game or a sports practice representing the location or movement of a ball and one or more players that involve in the sports game or practice, wherein the location or movement of the ball and the interaction or movement of the one or more players is the spatial and temporal relationships of the ball and said one or more players;
receiving a set of performance criteria data provided for evaluating the set of raw data;
comparing the set of raw data with the set of performance criteria data;
converting at least some of the set of raw data into a set of analytical data by measuring, predicting or inferring player or team values;
creating and then outputting a set of output data based on at least some of the set of analytical data; and
displaying at least some of the set of output data to evaluate or improve team strategy, player performance, or player selection.

2. The system according to claim 1, wherein said program instructions comprise at least one algorithm using at least one non-linear equation to extract the set of sports analytic data.

3. The system according to claim 1, wherein the operations further comprise applying when using said graph networks, at least partially, artificial intelligence to extract the set of sports analytic data.

4. The system according to claim 1, wherein the operations further comprise measuring, at least in part, physical or geometrical data comprising actual or potential interactions between multiple players and wherein the measuring comprises;
a. calculating precise values based on information or the derivative thereof, about spatial positions on the field, angles, distances, speeds, accelerations, and position imbalances; or
b. measuring precise actual or potential reactive movements of one or more players in response to the movement of one or more different players.

5. system according to claim 1, wherein the operation of converting uses, at least in part, graph nodes and edges which, in combination, at least partially evaluate desired dynamic sports interactions.

6. The system according to claim 1, wherein the said one or more graph networks comprises a forward predictive model, an inference model or a control model to provide, at least partially, processed sports data in the form of at least one graphic visualization showing player or team potential.

7. The system according to claim 1, wherein the output data comprises, at least in part, non-static dynamic information to predict at least one player's potential capability to perform within a team's actual or future playing strategy.

8. A computer-implemented method of holistically assessing sports team and player performance relating to the dynamic movement and interaction of multiple players on at least a portion of a field using one or more graph networks comprising:
receiving a set of video game images or a set of tracking data collected by wearable tracking devices worn by sports players during sports practices;
deriving a set of player or team sport performance data from the set of video game images or the set of tracking data;
receiving at least one set of performance criteria;
producing a set of holistic and non-static predictive sports analytics data by using at least one predictive sports analytic program or algorithm to assign player or team values by measuring, predicting or inferring from the set of player or team performance data, wherein said at least one program or algorithm measures past sports interactions game or tracking based, at least in part, upon a holistic and non-static spatial and temporal relationship between the movement of a ball and two or more players within at least a part of the playing field, and wherein the measuring comprises predicting, inferring or calculating values using spatial positions of the ball and the two or more players on the field, angles, distances, speeds, accelerations, position imbalances or any derivatives thereof; and
outputting a set of desired user data based upon the set of holistic and non-static predictive sports analytics data and the set of performance criteria.

9. The method according to claim 8, wherein the step of using said one or more graph networks to perform said measuring, predicting or inferring comprises graph nodes and edges which, in combination, at least partially evaluate desired dynamic sports interactions.

10. The method according to claim 8, wherein said one or more graph networks comprise a forward predictive model, an inference model or a control model that provides, at least partially, processed sports data in the form of at least one graphic visualization showing player or team advantage potential.

11. The method according to claim 8, wherein said program instructions or said algorithm comprise using at least one non-linear equation to extract the set of sports analytic data.

12. The method according to claim 8, wherein the operations further comprise measuring, at least in part, physical or geometrical data comprising actual or potential interactions between multiple players and wherein the measuring comprises;
a. calculating precise values based on information or the derivative thereof, about spatial positions on the field, angles, distances, speeds, accelerations, and position imbalances; or
b. measuring precise actual or potential reactive movements of one or more players in response to the movement of one or more different players.

13. The method according to claim 8, wherein said player quality, force or vectors comprise calculations based upon speed, acceleration, lateral or vertical movement or change of direction of movement.

14. A system, comprising:
one or more computer processors, one or more computer-readable memories and one or more computer-readable, tangible storage devices, and one or more databases; and
at least one set of computer readable program instructions using at least one algorithm, stored on at least one of the one or more computer readable, tangible storage devices for execution by at least of the one or more computer processors via at least one of the one or more memories, to perform operations, the operations comprising:
receiving, processing or storing a set of raw data related to a holistic and non-static sports game or a sports practice representing the location or movement of a ball and one or more players that involve in the sports game or practice, wherein the location or movement of the ball and the one or more players is precisely measured based, at least in part, upon mass as defined by player quality, vectors, speed, acceleration, lateral or vertical movement or change of direction of movement;
utilizing said at least one algorithm to convert at least some of the set of raw data into a set of extracted sports analytical data by measuring, predicting or inferring player or team values;
receiving a set of performance criteria data provided for evaluating the set of raw data;
comparing said extracted data with said set of performance criteria data;
creating and then outputting a set of output data based on at least some of the set of analytical data; and
displaying at least some of the set of output data to evaluate or improve team strategy, player performance, or player selection.

15. The system according to claim 14, wherein said program instructions or said algorithm comprise at least one algorithm using at least one non-linear equation to extract the set of sports analytic data.

16. The system according to claim 14 wherein one or more graph networks having at least on algorithm are used to, at least in part, perform said operations.

17. The system according to claim 16 wherein said one or more graph networks use, at least in part, graph nodes and edges which, in combination, at least partially evaluate desired dynamic sports interactions.

18. The system according to claim 17, wherein the output data comprises, at least in part, non-static dynamic information to predict at least one player's potential capability to perform within a team's actual or future playing strategy.

19. The system according to claim 14 wherein said output data can be used to make hiring or salary decisions, to improve at least one player or a team performance, or to improve playing strategy.

20. The method according to claim 14, wherein the set of raw data related to a dynamic sports game or a sports practice comprises non-static, dynamic information of multiple off-ball player movements.
